(19) United States
(12) Patent Application Publication
(10) Pub. No.: US 2019/0391055 A1
(43) Pub. Date: Dec. 26, 2019

(54) AUTOMATED SAMPLE PREPARATION SYSTEM AND APPLICATIONS THEREOF

(71) Applicant: GENOMIC HEALTH, INC., Redwood City, CA (US)

(72) Inventors: Hubert Yeung, Millbrae, CA (US); Amy Lee Hsieh Yuan, Saratoga, CA (US); Chun Wai Lee, El Cerrito, CA (US); Gabriel Jesus Samuel Perlas Moraleda, Santa Clara, CA (US)

(21) Appl. No.: 16/449,033

(22) Filed: Jun. 21, 2019

Related U.S. Application Data
(60) Provisional application No. 62/687,887, filed on Jun. 21, 2018.
(60) Provisional application No. 62/821,375, filed on Mar. 20, 2019.

(51) Int. Cl. G01N 1/28; G01N 35/00

(52) U.S. Cl. CPC G01N 1/286; G01N 2001/2886; G01N 2035/00831; G01N 35/00732

(57) ABSTRACT

A system for automation of sample preparation is disclosed. The system for automation includes a fixture configured to hold a sample and a reader system configured for receiving information pertinent to the sample. In various implementations, the system includes a cutting system configured for removing a portion of the sample. In various implementations, the system includes a cutting system configured for cutting the sample into at least two portions. In various implementations, the system further includes a first bin for collecting a first portion of the at least two portions of the sample. In various implementations, the system also includes a second bin for collecting a second portion of the at least two portions of the sample. In various implementations, the plurality of specimens are arranged linearly along one direction or arranged laterally in a two-dimensional array.

### CROSS-REFERENCE TO RELATED APPLICATIONS

This application claims the benefit of priority under 35 U.S.C. § 119 from U.S. Provisional Patent Application 62/687,887 filed Jun. 21, 2018, and from U.S. Provisional Patent Application 62/821,375 filed Mar. 20, 2019, each of which is incorporated herein by reference in its entirety

### BACKGROUND

Traditionally, sample preparation, for example, for clinical or laboratory pathology tests, are conducted manually. The manual process of sample preparation has many disadvantages and limitations, including poor sample quality, limitations in consistency and uniformity of the prepared samples, and work-related hazards to the operator, including ergonomics issues related to repetitive manual functions for processing the samples.

Currently, manual preparation approaches, including for example, dissecting of a sample, rely on operator hand/eye coordination, which inevitably affects the consistency and accuracy of the sample being prepared, as well as the extended time required to perform such manual processing. In addition, exposure to hazardous samples, including bio-hazardous samples, can threaten health and safety of the operator due to exposure to the dangerous radiation and biohazards. Even for non-hazardous samples, the operator can sustain razor blade injury, for example, from a broken blade or laceration during manual dissection of the samples. Furthermore, manual dissection with a constant force applied to a sample on a glass surface can cause severe and chronic ergonomic issues, particular for the operator performing the same functions repetitively over a prolonged period.

Therefore, an improved approach to sample preparation that can alleviate some of the issues related to the existing manual processes is needed to modernize the preparation process in a laboratory or clinical setting with more efficient, safer, time-sensitive, and perhaps, automated approaches.

### SUMMARY

At least one aspect of the disclosure is directed to an automated sample preparation system. The system includes a fixture configured to hold a sample, and a reader system configured for receiving information pertinent to the sample. The system includes a cutting system configured for cutting the sample into at least two portions. The system further includes a first bin for collecting a first portion of the at least two portions of the sample and a second bin for collecting a second portion of the at least two portions of the sample.

In various implementations of the system, the fixture is configured to hold the sample on outer edges of the sample whereby the sample is in contact with the fixture less than about 10% of lateral surface area of the sample. In various implementations, the fixture is configured to hold the sample on outer edges of the sample whereby the sample is in contact with the fixture less than about 1% of lateral surface area of the sample. In various implementations, the sample includes a specimen disposed on a substrate. In various implementations, the substrate comprises a glass, a soda-lime glass, a polymer, a paraffin, filter paper, specimen collection paper, combination of binding chemistries, including N terminus, C terminus, and extracellular matrix proteins.

In various implementations, the cutting system includes a laser system from one of a femto-second laser system, a pico-second laser system, a nano-second laser system, a micro-second laser system, a carbon dioxide laser system, a mode-locked laser system, a pulsed-laser system, a Q-switched laser system, a Nd:YAG laser system, a continuous wave laser system, a dye-laser system, a tunable laser system, a Ti-Sapphire laser system, a high-power diode laser system, or a high-power fiber laser system. In various implementations, the cutting system includes a mechanical cutting tool having a stationary blade or a rotating blade.

In various implementations, the reader system includes an optical system for reading a barcode or quick response (QR) code, or a radio-frequency identification (RFID) system for reading an RFID tag. In various implementations, the reader system includes an image capturing system for imaging the sample or a video capturing system for monitoring the sample.

In various implementations, the first portion of the at least two portions of the sample comprises one or more regions of interest and the second portion of the at least two portions of the sample comprises one or more regions to be discarded. In various implementations, the first bin and the second bin move independently and in lateral directions.

In various implementations, the sample includes a plurality of specimens, each specimen disposed on a substrate. In various implementations, the plurality of specimens are arranged linearly along one direction or arranged laterally in a two-dimensional array.

At least one aspect of the disclosure is directed to a method for automated sample preparation. The method includes providing a sample having a specimen and affixing the sample to a fixture. The method also includes providing a reader system configured for receiving information pertinent to the sample. The method also includes cutting the sample via a cutting system configured for cutting the sample into at least two portions. The method further includes collecting a first portion of the at least two portions of the sample into a first bin and collecting a second portion of the at least two portions of the sample into a second bin.

In various implementations of the method, the sample is affixed to the fixture on outer edges of the sample whereby the sample is in contact with the fixture less than about 10% of lateral surface area of the sample. In various implementations, the sample is affixed to the fixture on outer edges of the sample whereby the sample is in contact with the fixture less than about 1% of lateral surface area of the sample. In various implementations, the sample includes a substrate on which the specimen is disposed. In various implementations, the substrate includes a glass, a soda-lime glass, a polymer, a paraffin, filter paper, specimen collection paper, combination of binding chemistries, including N terminus, C terminus, and extracellular matrix proteins.

In various implementations of the method, the cutting system includes a laser system from one of a femto-second laser system, a pico-second laser system, a nano-second laser system, a micro-second laser system, a carbon dioxide laser system, a mode-locked laser system, a pulsed-laser system, a Q-switched laser system, a Nd:YAG laser system, a continuous wave laser system, a dye-laser system, a tunable laser system, a Ti-Sapphire laser system, a high-power diode laser system, or a high-power fiber laser system. In various implementations, the cutting system includes a mechanical cutting tool having a stationary blade or a rotating blade.

In various implementations, the reader system includes an optical system for reading a barcode or QR code, or a RFID system for reading an RFID tag, and the information pertinent to the sample comprises one of a position, a location, or coordinates for one or more regions of interest. In various implementations, the reader system includes an image capturing system for imaging the sample or a video capturing system for monitoring the sample.

In various implementations, the first portion of the at least two portions of the sample comprises one or more regions of interest and the second portion of the at least two portions of the sample comprises one or more regions to be discarded. In various implementations, the first bin and the second bin move independently and in lateral directions.

In various implementations, the sample includes a plurality of specimens, each specimen disposed on a substrate, and the plurality of specimens are arranged linearly along one direction or arranged laterally in a two-dimensional array.

At least one aspect of the disclosure is directed to an automated sample preparation system. The system includes a fixture for holding a sample having a portion of interest. The system also includes a reader system configured for receiving information pertinent to the sample. The system includes a laser system configured for isolating the portion of interest from the sample. The system further includes a collection bin configured for collecting the isolated portion of interest.

In various implementations of the system, the sample includes a plurality of portions of interest, the laser system isolates each of the plurality of portions of interest, and the collection bin collects each of the isolated portions of interest.

In various implementations of the system, the fixture holds the sample on its outer edges and the sample is in contact with the fixture less than about 10% of lateral surface area of the sample.

In various implementations of the system, the laser system includes one of a femto-second laser system, a pico-second laser system, a nano-second laser system, a micro-second laser system, a carbon dioxide laser system, a mode-locked laser system, a pulsed-laser system, a Q-switched laser system, a Nd:YAG laser system, a continuous wave laser system, a dye-laser system, a tunable laser system, a Ti-Sapphire laser system, a high-power diode laser system, or a high-power fiber laser system.

In various implementations of the system, the reader system includes an optical system for reading a barcode or QR code, or a RFID system for reading an RFID tag, or an image capturing system for imaging the sample or a video capturing system for monitoring the sample, and wherein the information pertinent to the sample comprises one of a position, a location, or coordinates for the portion of interest.

At least one aspect of the disclosure is directed to an automated sample preparation system. The system includes a fixture configured for securing a sample having a specimen disposed on a substrate. The system also includes a reader system configured for receiving information pertinent to the sample. The system includes an ultra-short pulsed laser system configured for removing at least a portion of the specimen. In various implementations, removing includes vaporizing or eradicating the at least a portion of the specimen.

In various implementations, the reader system includes an optical system for reading a barcode or QR code, or a RFID system for reading an RFID tag, or an image capturing system for imaging the sample or a video capturing system for monitoring the sample, and wherein the information pertinent to the sample comprises one of a position, a location, or coordinates for the portion of interest.

In various implementations, the ultra-short pulsed laser system includes one of a femto-second laser system, a pico-second laser system, a nano-second laser system, or a microsecond laser system.

In various implementations, the sample includes a plurality of specimens, each specimen disposed on a substrate, wherein the plurality of specimens are arranged linearly along one direction or arranged laterally in a two-dimensional array. In various implementations, the fixture is configured to hold the sample on outer edges of the substrate whereby the substrate is in contact with the fixture less than about 10% of lateral surface area of the substrate.

At least one aspect of the disclosure is directed to a method for automated sample preparation. The method includes providing a substrate having a specimen disposed thereon and affixing the substrate to a fixture. The method includes providing a reader system configured for receiving information pertinent to the specimen. The method also includes removing a plurality of portions of the specimen via an ultra-short pulsed laser system thereby forming the specimen with a region of interest. The method further includes collecting the specimen with the region of interest for laboratory testing. In various implementations, removing via the ultra-short pulsed laser system includes removing the plurality of portions of the specimen without damaging the region of interest in the specimen.

In various implementations, the substrate is affixed to the fixture on outer edges of the substrate whereby the substrate is in contact with the fixture less than about 10% of lateral surface area of the substrate. In various implementations, the substrate is affixed to the fixture on outer edges of the substrate whereby the substrate is in contact with the fixture less than about 1% of lateral surface area of the substrate. In various implementations, the substrate comprises a glass, a soda-lime glass, a polymer, a paraffin, filter paper, specimen collection paper, combination of binding chemistries, including N terminus, C terminus, and extracellular matrix proteins.

In various implementations, the ultra-short pulsed laser system includes one of a femto-second laser system, a pico-second laser system, a nano-second laser system, or a microsecond laser system.

In various implementations, the reader system includes an optical system for reading a barcode or quick response (QR) code or a radio-frequency identification (RFID) system for reading an RFID tag. In various implementations, the information pertinent to the specimen includes one of a position, a location, or coordinates for one or more regions of interest in the specimen. In various implementations, the reader system includes an image capturing system for imaging the specimen or a video capturing system for monitoring the specimen.

In various implementations, a plurality of substrates are affixed to the fixture, each of the plurality of substrates having a specimen, and the substrates are arranged linearly along one direction or arranged laterally in a two-dimensional array on the fixture.

These and other aspects and implementations are discussed in detail below. The foregoing information and the following detailed description include illustrative examples of various aspects and implementations, and provide an overview or framework for understanding the nature and character of the claimed aspects and implementations. The drawings provide illustration and a further understanding of the various aspects and implementations, and are incorporated in and constitute a part of this specification.

### BRIEF DESCRIPTION OF THE DRAWINGS

The accompanying drawings are not intended to be drawn to scale. Like reference numbers and designations in the various drawings indicate like elements. For purposes of clarity, not every component may be labeled in every drawing. In the drawings:

FIGS. 1A, 1B and 1C are schematic views of an implementation of an automated sample preparation system, according to various embodiments;

FIG. 2 is a schematic block diagram of an automated sample preparation system, according to various embodiments;

FIGS. 3A-3H are schematic views of example sample markings used in automated sample preparation, according to various embodiments;

FIG. 4 is a flowchart of an example method for automating sample preparation, according to an illustrative implementation;

FIG. 5 is a flowchart of another example method for automating sample preparation, according to an illustrative implementation.

### DETAILED DESCRIPTION

The technology disclosed herein relates generally to an automated sample preparation system and a method for automating the sample preparation. The automated system can include a sample affixed to a fixture and a reader system configured for receiving information pertinent to the sample. In various implementations, the system can include a cutting system configured for removing a portion of the sample. In various implementations, the system can include a cutting system configured for cutting the sample into at least two portions. In various implementations, the system further can include a first bin for collecting a first portion of the at least two portions of the sample. In various implementations, the system also can include a second bin for collecting a second portion of the at least two portions of the sample.

In various implementations as described herein, the automated sample preparation system can be configured to automate the sample preparation process by automatically dissecting the sample in accordance with the information provided to the system via the reader system. The sample information received in the reader system that is communicatively coupled to the automated sample preparation system can be used by the cutting system to either remove some portions of the sample or cut the sample into at least two portions.

In various implementations, the sample can be marked (for example, but not limited to, via a pen or digitally marked via software) to indicate one or more regions of interest (ROI), e.g., “wanted” portions, and/or one or more regions of exclusion (ROE), e.g., “unwanted” portions. After feeding the information related to the sample into the cutting system, some portions of the sample that are marked as “S” for the ROI areas are cut, collected and tested, while some portions of the sample that are marked as “X” for the ROE areas are either collected to be discarded, simply discarded by destroying those portions or otherwise removed from the sample.

In various implementations, the S portions and the X portions can be collected separately into separate containers. In various implementations, the S portions can be collected into a container and the X portions are destroyed or removed from existence. In various implementations, the S portions can be collected into a container and the X portions are broken into pieces to be discarded in a separate container. In various implementations, the X portions can be removed from the sample only, with the S portions left remaining on the sample, which can be then collected for further processing. In various implementations, after the unwanted X portion or portions are removed from the sample, the sample can be then considered to contain only the wanted S portions that are to be examined or characterized in a clinical or laboratory test.

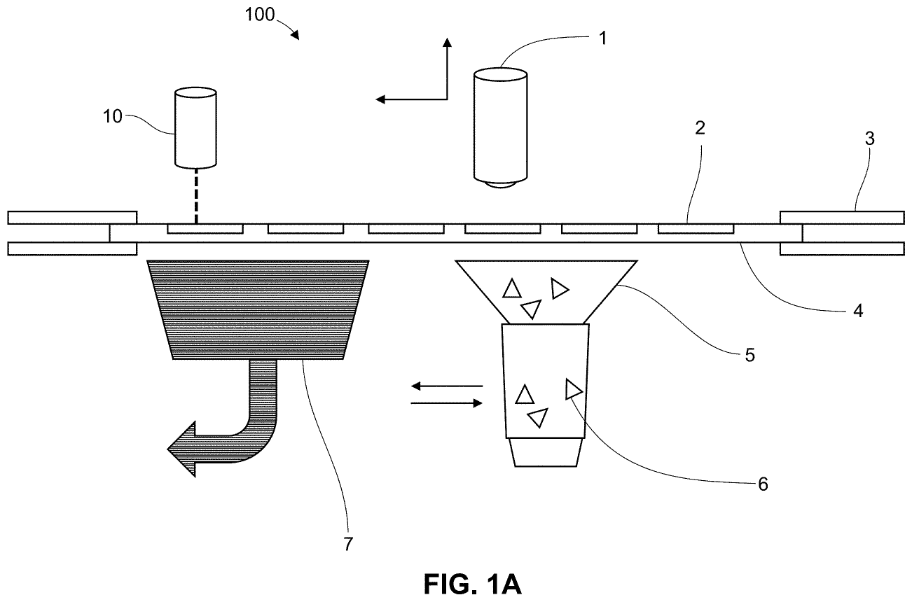

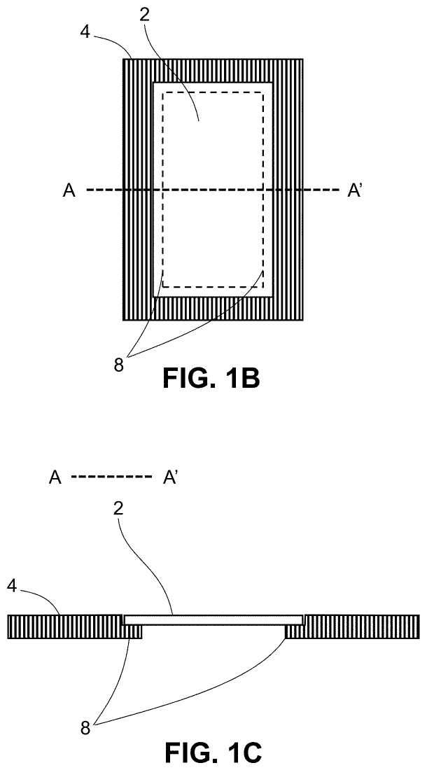

FIG. 1A shows a schematic view of an example automated sample preparation system 100, in accordance with various embodiments described herein. As shown in FIG. 1A, the system 100 can include a laser system 1 that can be configured to remove or cut a portion of a sample 2 held in a fixture 4 that is secured by a clamp 3. The system 100 can also include a reader system 10 that can be configured to receive information pertinent to the sample 2 and/or fixture 4. In various implementations, the fixture 4 can hold multiple samples 2 that are arranged along a single direction or arranged in an array in two directions. The system 100 can also include a collection bin 5 used for collecting a plurality of wanted ROI portions 6, and a collection bin 7 for collecting unwanted portions.

As shown in FIG. 1A, the laser system 1 can be configured to move in any of one-dimension, two-dimension, or three-dimension configurations with respect to the sample 2. In various implementations, the one-dimension configuration of the laser system 1 refers to, for example, “x-direction” across FIG. 1A from left to right or vice versa. In various implementations, the two-dimension configuration refers to, for example, “x and y-directions” across FIG. 1A from left to right or vice versa, and into and out of the page with respect to the position of the sample 2. In various implementations, the three-dimension configuration refers to, for example, “x, y, and z-directions” where the z-direction adjusts for focusing of the laser beam of the laser system 1 with respect to the surface of the sample 2. In various implementations, the z-direction can be also used for determining how far into sample 2 the laser system 1 is cutting or removing a portion of the sample 2.

FIG. 1B shows a schematic top view of the sample 2 in the fixture 4 and FIG. 1C shows a cross-sectional view A-A′ of the sample 2 in the fixture 4, according to various embodiments. As shown in FIGS. 1B and 1C, the fixture 4 can be configured to affix the sample 2 by placing the sample 2 inside a ledge 8 in the fixture 4. In various implementations, the fixture 4 can be configured to hold the sample 2 by vacuum suction. In various implementations, the fixture 4 can be configured to hold the sample 2 via a magnetic attachment mechanism. In various implementations, the fixture 4 can be configured to hold the sample 2 via for example, but not limited to, a spring-loaded pin or hinge mechanism, a toggle clamp mechanism, or a compression interference fit elastic mounting plate.

In various implementations, the fixture 4 can be configured to hold a plurality of samples 2, each of the samples 2 having a specimen disposed on a substrate. In various implementations where the fixture 4 holds more than one sample 2, the laser system 1 can be configured to move from a first sample 2 to a second or an adjacent sample 2, or any of the samples 2 placed in the fixture 4. In other words, the laser system 1 can be configured to perform removal or cutting on the first sample 2, as well as on the second or the adjacent sample 2, or any of the samples 2 placed in the fixture 4.

In various implementations, the sample 2 can include a plurality of specimens disposed on a single substrate. In various implementations, the plurality of specimens can be arranged linearly along one direction or arranged laterally in a two-dimensional array on the substrate.

In various implementations, the automated sample preparation system 100 can be used for preparing pre-enrichment or isolation of a specimen. In various implementations, the specimen to be prepared using the automated sample preparation system 100 can be a tissue specimen that is prepared using a standard Formalin-Fixed Paraffin-Embedded (FFPE) approach, including any biological tissue specimen in need of preparation for clinical or laboratory analysis. In various implementations, the sample can be prepared using any other suitable sample preparation approaches currently used in laboratory or clinical testing. In various implementations, the specimen or specimen types that can be prepared using the automated sample preparation system 100 can include, but not limited to, FFPE tissue blocks, cell cultures, frozen sections, fresh tissue, liquid biopsy, including blood and urine, cytology samples (i.e., sputum, pleural fluid, etc.). In various implementations, the specimen types can also include, non-human targets.

In various implementations, the specimen can be prepared to be contained in a scaffold during the sample preparation. After the cutting or removal of the unwanted portion or portions of the specimen, the wanted portions of the specimen can be removed from the scaffold via any suitable method, including, but not limited to, the use of electrostatic methods, hydration, mechanical, pneumatic, or a combination of the above methods.

In various implementations, the substrate can be a glass, a soda-lime glass, a polymer, a paraffin, filter paper, specimen collection paper, combination of binding chemistries, including N terminus, C terminus, extracellular matrix proteins. In various implementations, the specimen can be prepared in any form factor vessel, including, but not limited to coverslips (i.e., blood smear generation), bioreactors, cell culture dishes with imaging punches, liquid streams, or liquid droplets, etc.

In various implementations, the sample 2 can include a barcode, a quick response (QR) code, or a radio-frequency identification (RFID) tag for providing information pertinent to the sample 2. In various implementations, the sample 2 can include markings on the sample for reading with an image capturing system for imaging the markings on the sample 2. In various implementations, the sample 2 can include markings on the sample 2 for a video capturing system for monitoring the markings on the sample 2.

In various implementations, the fixture 4 can include a barcode or QR code, or a RFID tag for providing information pertinent to the sample 2 or each of the samples 2 being held by the fixture 4. In various implementations, one or more of the codes or tags on the fixture 4 may include information pertinent to the locations of each of the samples 2 or markings on each of the samples 2 that are readable by the reader system 10, including, but not limited to, a barcode reader, a QR code reader, an RFID reader, an image capturing system for imaging the markings on or position of each of the sample 2, or a video capturing system for monitoring the markings on or position of each of the sample 2.

In various implementations of the system 100, the sample 2 can be affixed to the fixture on outer edges of the sample whereby the sample 2 is in contact with the fixture 4 less than about 10% of lateral surface area of the sample 2. As described herein, the sample 2 can refer to, for example, the sample itself that includes the specimen, a substrate housing the sample or the specimen, a scaffold housing or affixing the specimen, etc., and therefore, it can generally refer to any specimen-containing article or article having a specimen attached thereto. In various implementations, the sample 2 can be affixed to the fixture on outer edges of the sample 2 whereby the sample is in contact with the fixture less than about 1% of lateral surface area of the sample 2. In other words, the sample 2 can be placed on a ledge within a slot on the fixture 2 so that less than about 20%, less than about 10% or less than about 1% of contact occurs between the sample 2 and the fixture 4.

In various implementations, the laser system 1 used for removing or cutting a portion of the sample 2 can be any laser system, for example, but not limited to, a femto-second laser system, a pico-second laser system, a nano-second laser system, a micro-second laser system, a carbon dioxide laser system, a mode-locked laser system, a pulsed-laser system, a Q-switched laser system, a Nd:YAG laser system, a continuous wave laser system, a dye-laser system, a tunable laser system, a Ti-Sapphire laser system, a high-power diode laser system, or a high-power fiber laser system.

In various implementations, the laser system 1 can remove some portions of the sample 2 without damaging other portions of the sample 2. For example, the laser system 1 can be configured to remove all unwanted portions of sample 2 without damaging the wanted regions of interest in the specimen of the sample 2. In various implementations, the laser system 1 can be configured to cut the sample 2 into at least two portions that include one or more “S” portions and one or more “X” portions. In various implementations, instead of cutting “X” portions, the laser system 1 can be configured to destroy or remove the “X” portions of the sample 2.

In various implementations, instead of a laser system 1, a mechanical cutting system can be used for removing or cutting a portion of the sample 2. In some implementations, the mechanical cutting system can include a mechanical cutting tool having a stationary blade or a rotating blade, a radio frequency (RF) ablating, micro-bead blasting, or any other suitable mechanical means of cutting, including ultrasonic cutting.

In various implementations, the reader system 10 can include a barcode reader, a QR code reader, an RFID reader, an image capturing system for imaging the markings on or position of the sample 2, or a video capturing system for monitoring the markings on or position of the sample 2. In various implementations, the image capturing system can be coupled with a decoding system or an image processing system to further process the images captured. In various implementations, the video capturing system can be coupled with a decoding system or a video processing system to further process the video captured.

In various implementations, the system 100 can include a collection bin 5 used for collecting a plurality of wanted ROI portions 6, and a collection bin 7 for collecting unwanted portions. In various implementations, the collection bin 5 moves automatically to collect the plurality of wanted ROI portions 6. In various implementations, the collection bin 7 moves automatically to collect the unwanted portions. In various implementations, the collection bin 5 and the collection bin 7 are configured to move in any of one dimension (x-direction), two dimensions (x and y-directions), or three dimensions (x, y, and z-directions), automatically and independently, to collect the corresponding portions of the sample 2.

In various implementations, a robotic arm (not shown) may be employed to collect either of the wanted “S” or unwanted “X” cut portions to be disposed into one of the collection bins 5 or 7.

In various implementations, the system 100 can also include an imaging system (not shown) for capturing images or videos of the before, during and after cutting of the sample 2. In various implementations, the imaging system can also capture images and videos of a portion or an entire automated system. In various implementations, the system 100 includes collecting information related to the collection bins 5 and 7 and record information related to each of the “S” and “X” portions collected in the bins 5 and/or 7.

In various implementations, a cleaning mechanism can be employed between successive sample cuttings to avoid cross-contamination between different samples mounted on the fixture 2.

According to various implementations as described herein with respect to FIG. 1A, an automated sample preparation system is described in detail. The system includes a sample having a specimen disposed on a substrate, and a fixture for securing the substrate. Again, as described herein, the sample refers to, for example, the sample itself that includes the specimen, a substrate housing the sample or the specimen, a scaffold housing or affixing the specimen, etc., and therefore, it generally refers to any specimen-containing article or any article having a specimen attached thereto. The system also includes a reader system configured for receiving information pertinent to the sample. The system includes an ultra-short pulsed laser system configured for removing at least a portion of the specimen. In various implementations, removing includes vaporizing, ablating, burning, melting, decomposing, or eradicating the at least a portion of the specimen.

According to various implementations as described herein with respect to FIG. 1A, another automated sample preparation system is described in detail. The system includes a sample affixed to a fixture and a reader system configured for receiving information pertinent to the sample. The system can include a cutting system configured for cutting the sample into at least two portions. The system further can include a first bin for collecting a first portion of the at least two portions of the sample and a second bin for collecting a second portion of the at least two portions of the sample.

According to various implementations as described herein with respect to FIG. 1A, yet another automated sample preparation system is described in detail. The system includes a sample having a portion of interest and a fixture for holding the sample. The system also can include a reader system configured for receiving information pertinent to the sample. The system can include a laser system configured for isolating the portion of interest from the sample. The system can further include a collection bin configured for collecting the isolated portion of interest.

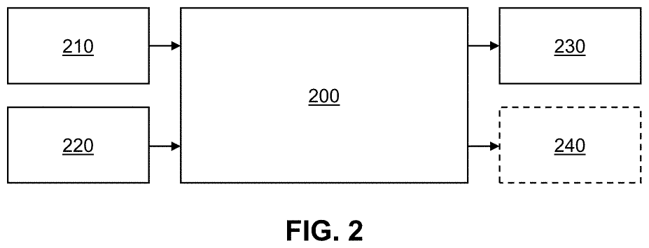

FIG. 2 shows a schematic block diagram of an automated sample preparation system 200, according to various embodiments as described herein. The schematic block diagram of FIG. 2 illustrates relationships between inputs 210 and 220, the system 200, and outputs 230 and 240. As shown in FIG. 2, the system 200 is configured to receive a sample 210 and information 220 pertinent to the sample 210 for automated preparation. Regarding information 220, system 200 can have a reader system (discussed herein) configured to receive said pertinent information. Once the system 200 receives the inputs 210 and 220, the system 200 can undergo automated sample preparation (discussed in detail herein) to output the prepared sample 230 containing one or more regions of interest, such as, the wanted “S” portions into a container or a collection bin. In some implementations, the system 200 can optionally output the unwanted “X” portions as the output 240, which can be a container or a collection bin.

Based on the configurations illustrated in FIGS. 1 and 2, the automated sample preparation system 100 (or system 200) can be employed to perform automated sample preparations for different use cases as illustrated below.

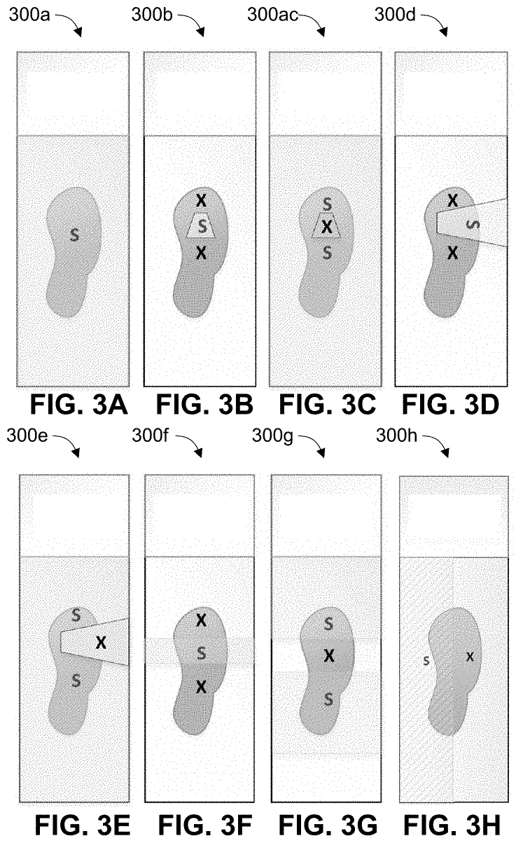

FIGS. 3A-3H are schematic views of example sample markings (for example, digital or pen) used in automated sample preparation, according to various embodiments. In each of the FIGS. 3A-3H, the “S” area indicates the wanted region of interest and the “X” area indicates the unwanted regions or portions. For discussion of FIGS. 3A-3H, although a laser system is described to perform the removal or cutting, it is understood that a mechanical cutting system can be employed in place of the laser system.

FIG. 3A shows a sample 300a with a specimen containing an entire region of “S”. In this case, a “straight pass” method can be applied, for example, via a mechanical scraping mechanism to collect all the FFPE tissue from the substrate (e.g., a glass slide).

FIG. 3B shows a sample 300b with a specimen containing an “S” portion surrounded by “X” portions. In this case, the “S” portion can be cut out by a laser system or the “X” portions can be destroyed by the laser system leaving the “S” portion in the sample 300b.

FIG. 3C shows a sample 300c with a specimen containing an “X” portion surrounded by “S” portions. In this case, the “X” portion can be cut out or removed by the laser system. After the “X” portion is cut out or removed, the remainder “S” portions can be scraped to collect all the wanted regions of interest.

FIG. 3D shows a sample 300d with a specimen containing an “S” portion near one edge of the sample surrounded by “X” portions. In this case, the “S” portion can be cut out by a laser system leaving only the “X” portions of the sample 300d. The sample 300d then can be discarded or destroyed by the laser system.

FIG. 3E shows a sample 300e with a specimen containing an “X” portion near one edge of the sample surrounded by “S” portions. In this case, the “X” portion can be cut out or removed by the laser system, leaving the “S” portions of the sample 300e. The remainder “S” portions can be scraped to collect all the wanted regions of interest.

FIG. 3F shows a sample 300f with a specimen containing an “S” portion between two “X” portions. In this case, the “X” portions can be cut out or removed by a laser system leaving only the “S” portion of the sample 300f. Alternatively, the sample 300f can be cut along the two borders between the “S” portion and the “X” portions by the laser system and collect the “S” portion in a container bin and discard two “X” portions.

FIG. 3G shows a sample 300g with a specimen containing an “X” portion between two “S” portions. In this case, the “X” portion can be cut out or removed by a laser system leaving only the “S” portions of the sample 300g. Alternatively, the sample 300g can be cut along the two borders between the “X” portion and the “S” portions by the laser system and collect the two “S” portions in a container bin and discard the “X” portion.

FIG. 3H shows a sample 300h with a specimen containing an “S” portion and an “X” portion. In this case, the “X” portion can be cut out or removed by a laser system leaving only the “S” portion of the sample 300h. Alternatively, the sample 300h can be cut along the border between the “S” portion and the “X” portion by the laser system and collect the “S” portion in a container bin and discard the “X” portion.

In various implementations described with respect to FIGS. 3A-3H, scraping can be implemented to collect the “S” portion (or portions) for clinical or laboratory testing. In various implementations, lysis (e.g., direct lysis tissue) can be implemented to collect the “S” wanted portions. In various implementations, a media can be used to remove the “S” wanted portions.

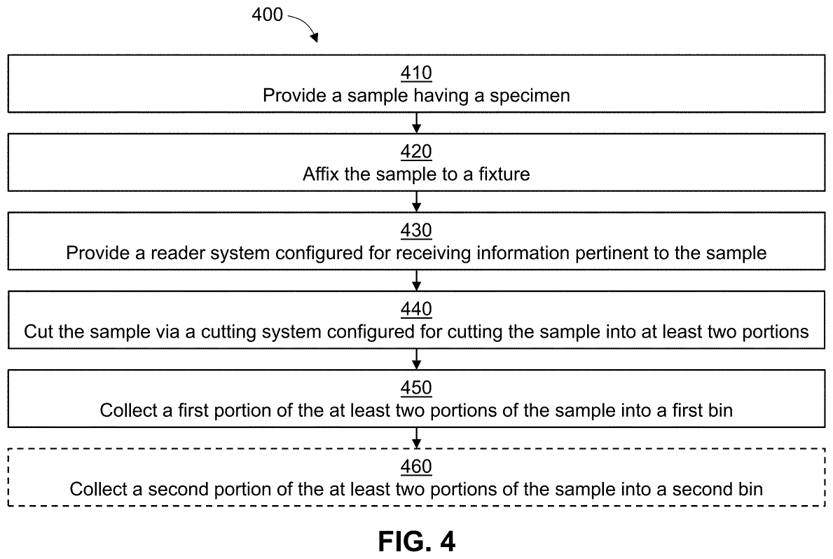

FIG. 4 shows a flowchart of an example method 400 for automating sample preparation, according to various embodiments. As shown in FIG. 4, the method 400 includes at step 410 providing a sample having a specimen. In various implementations, the specimen can be, for example, digitally or pen-marked with wanted “S” portions and/or unwanted “X” portions. As described herein the “S” portions include regions of interest that are to be analyzed and the “X” portions are to be discarded.

As shown in FIG. 4, the method 400 includes at step 420 affixing the sample to a fixture, which can be configured to hold the sample. As described herein, the sample can refer to, for example, the sample itself that includes the specimen, a substrate housing the sample or the specimen, a scaffold housing or affixing the specimen, etc. Therefore, it can generally refer to any specimen-containing article or any article having a specimen attached thereto. In various implementations, the fixture can be configured to hold multiple samples. The method 400 includes at step 430 providing a reader system configured for receiving information pertinent to the sample or samples. The pertinent information includes locations and positions of the “S” and “X” portions of the sample or samples.

At step 440, the method 400 includes cutting the sample via a cutting system configured for cutting the sample into at least two portions. In various implementations, the cutting system can be a laser system used for removing or cutting out the unwanted “X” portions from the sample. In various implementations, the laser system can be any laser system including, but not limited to, for example a femto-second laser system, a pico-second laser system, a nano-second laser system, a micro-second laser system, a carbon dioxide laser system, a mode-locked laser system, a pulsed-laser system, a Q-switched laser system, a Nd:YAG laser system, a continuous wave laser system, a dye-laser system, a tunable laser system, a Ti-Sapphire laser system, a high-power diode laser system, or a high-power fiber laser system. In various implementations, the cutting system can be a mechanical cutting system via a rotating or stationary blade.

At step 450, the method 400 also includes collecting a first portion of the at least two portions of the sample into a first bin. In various implementations, the first bin is configured to collect the wanted “S” portions. At step 460, the method 400 optionally includes collecting a second portion of the at least two portions of the sample into a second bin. In various implementations, the second bin is configured to collect the unwanted “X” portions.

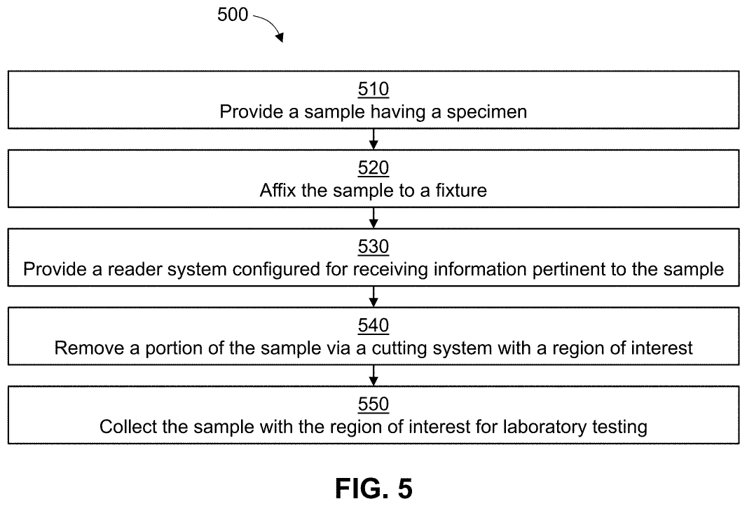

FIG. 5 shows a flowchart of another example method 500 for automating sample preparation, according to an illustrative implementation. As shown in FIG. 5, the method 500 includes at step 510 providing a sample having a specimen. In various implementations, the specimen can be marked, for example, digitally or pen-marked with wanted “S” portions and/or unwanted “X” portions. As described herein the “S” portions include regions of interest that are to be analyzed and the “X” portions are to be discarded.

As shown in FIG. 5, the method 500 includes at step 520 affixing the sample to a fixture. In various implementations, the fixture can be configured to hold multiple samples. The method 500 includes at step 530 providing a reader system configured for receiving information pertinent to the sample or samples. The pertinent information can include locations and positions of the “S” and “X” portions of the sample or samples.

At step 540, the method 500 includes removing or cutting a portion of the sample (e.g., the “X” portions) via a cutting system to obtain the sample with a region of interest (i.e., the “S” portions). In various implementations, the removing includes using an ultra-short pulsed laser system to remove the “X” portions of the sample without damaging the region of interest in the specimen. In various implementations, the ultra-short pulsed laser system can be one of a femto-second laser system, a pico-second laser system, a nano-second laser system, or a microsecond laser system.

In various implementations, the cutting system can be any laser system used for removing or cutting out the unwanted “X” portions from the sample. In various implementations, the cutting system can be a mechanical cutting system via a rotating or stationary blade.

At step 550, the method 500 also includes collecting the sample with the region of interest (e.g., wanted “S” region) for clinical or laboratory testing.

While this specification contains many specific implementation details, these should not be construed as limitations on the scope of any inventions or of what may be claimed, but rather as descriptions of features specific to particular implementations of particular inventions. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products.

References to “or” may be construed as inclusive so that any terms described using “or” may indicate any of a single, more than one, and all of the described terms. The labels “first,” “second,” “third,” and so forth are not necessarily meant to indicate an ordering and are generally used merely to distinguish between like or similar items or elements.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein.

### Recitation of Embodiments

1. An automated sample preparation system comprising a fixture configured to hold a sample; a reader system configured for receiving information pertinent to the sample; a cutting system configured for cutting the sample into at least two portions; a first bin for collecting a first portion of the at least two portions of the sample; and a second bin for collecting a second portion of the at least two portions of the sample.

2. The system of Embodiment 1, wherein the fixture is configured to hold the sample on outer edges of the sample whereby the sample is in contact with the fixture less than about 10% of lateral surface area of the sample.

3. The system of Embodiment 1 or Embodiment 2, wherein the fixture is configured to hold the sample on outer edges of the sample whereby the sample is in contact with the fixture less than about 1% of lateral surface area of the sample.

4. The system of any one of Embodiments 1 to 3, wherein the sample comprises a specimen disposed on a substrate.

5. The system of Embodiment 4, wherein the substrate comprises a glass, a soda-lime glass, a polymer, a paraffin, filter paper, specimen collection paper, combination of binding chemistries, including N terminus, C terminus, extracellular matrix proteins.

6. The system of any one of Embodiments 1 to 5, wherein the cutting system comprises a laser system from one of a femto-second laser system, a pico-second laser system, a nano-second laser system, a micro-second laser system, a carbon dioxide laser system, a mode-locked laser system, a pulsed-laser system, a Q-switched laser system, a Nd:YAG laser system, a continuous wave laser system, a dye-laser system, a tunable laser system, a Ti-Sapphire laser system, a high-power diode laser system, or a high-power fiber laser system.

7. The system of any one of Embodiments 1 to 6, wherein the cutting system comprises a mechanical cutting tool having a stationary blade or a rotating blade.

8. The system of any one of Embodiments 1 to 7, wherein the reader system comprises an optical system for reading a barcode or quick response (QR) code or a radio-frequency identification (RFID) system for reading an RFID tag.

9. The system of any one of Embodiments 1 to 8, wherein the reader system comprises an image capturing system for imaging the sample or a video capturing system for monitoring the sample.

10. The system of any one of Embodiments 1 to 9, wherein the first portion of the at least two portions of the sample comprises one or more regions of interest and the second portion of the at least two portions of the sample comprises one or more regions to be discarded.

11. The system of any one of Embodiments 1 to 10, wherein the first bin and the second bin move independently and in lateral directions.

12. The system of any one of Embodiments 1 to 11, wherein the sample comprises a plurality of specimens, each specimen disposed on a substrate.

13. The system of Embodiment 12, wherein the plurality of specimens are arranged linearly along one direction or arranged laterally in a two-dimensional array.

14. A method for automated sample preparation, the method comprising providing a sample having a specimen; affixing the sample to a fixture; providing a reader system configured for receiving information pertinent to the sample; cutting the sample via a cutting system configured for cutting the sample into at least two portions; collecting a first portion of the at least two portions of the sample into a first bin; and collecting a second portion of the at least two portions of the sample into a second bin.

15. The method of Embodiment 14, wherein the sample is affixed to the fixture on outer edges of the sample whereby the sample is in contact with the fixture less than about 10% of lateral surface area of the sample.

16. The method of Embodiment 14 or Embodiment 15, wherein the sample is affixed to the fixture on outer edges of the sample whereby the sample is in contact with the fixture less than about 1% of lateral surface area of the sample.

17. The method of any one of Embodiments 14 to 16, wherein the sample comprises a substrate on which the specimen is disposed.

18. The method of any one of Embodiments 14 to 17, wherein the substrate comprises a glass, a soda-lime glass, a polymer, a paraffin, filter paper, specimen collection paper, combination of binding chemistries, including N terminus, C terminus, extracellular matrix proteins.

19. The method of any one of Embodiments 14 to 18, wherein the cutting system comprises a laser system from one of a femto-second laser system, a pico-second laser system, a nano-second laser system, a micro-second laser system, a carbon dioxide laser system, a mode-locked laser system, a pulsed-laser system, a Q-switched laser system, a Nd:YAG laser system, a continuous wave laser system, a dye-laser system, a tunable laser system, a Ti-Sapphire laser system, a high-power diode laser system, or a high-power fiber laser system.

20. The method of any one of Embodiments 14 to 19, wherein the cutting system comprises a mechanical cutting tool having a stationary blade or a rotating blade.

21. The method of any one of Embodiments 14 to 20, wherein the reader system comprises an optical system for reading a barcode or quick response (QR) code or a radio-frequency identification (RFID) system for reading an RFID tag, and the information pertinent to the sample comprises one of a position, a location, or coordinates for one or more regions of interest.

22. The method of any one of Embodiments 14 to 21, wherein the reader system comprises an image capturing system for imaging the sample or a video capturing system for monitoring the sample.

23. The method of any one of Embodiments 14 to 22, wherein the first portion of the at least two portions of the sample comprises one or more regions of interest and the second portion of the at least two portions of the sample comprises one or more regions to be discarded.

24. The method of any one of Embodiments 14 to 23, wherein the first bin and the second bin move independently and in lateral directions.

25. The method of any one of Embodiments 14 to 24, wherein the sample comprises a plurality of specimens, each specimen disposed on a substrate, and wherein the plurality of specimens are arranged linearly along one direction or arranged laterally in a two-dimensional array.

26. An automated sample preparation system comprising a fixture for holding a sample having a portion of interest; a reader system configured for receiving information pertinent to the sample; a laser system configured for isolating the portion of interest from the sample; and a collection bin configured for collecting the isolated portion of interest.

27. The system of Embodiment 26, wherein the sample comprises a plurality of portions of interest, the laser system isolates each of the plurality of portions of interest, and the collection bin collects each of the isolated portions of interest.

28. The system of Embodiment 26 or Embodiment 27, wherein the fixture holds the sample on its outer edges and the sample is in contact with the fixture less than about 10% of lateral surface area of the sample.

29. The system of any one of Embodiments 26 to 28, wherein the laser system comprises one of a femto-second laser system, a pico-second laser system, a nano-second laser system, a micro-second laser system, a carbon dioxide laser system, a mode-locked laser system, a pulsed-laser system, a Q-switched laser system, a Nd:YAG laser system, a continuous wave laser system, a dye-laser system, a tunable laser system, a Ti-Sapphire laser system, a high-power diode laser system, or a high-power fiber laser system.

30. The system of any one of Embodiments 26 to 29, wherein the reader system comprises an optical system for reading a barcode or quick response (QR) code, a radio-frequency identification (RFID) system for reading an RFID tag, or an image capturing system for imaging the sample or a video capturing system for monitoring the sample, and wherein the information pertinent to the sample comprises one of a position, a location, or coordinates for the portion of interest.

31. An automated sample preparation system comprising a fixture configured for securing a sample having a specimen disposed on a substrate; a reader system configured for receiving information pertinent to the sample; and an ultra-short pulsed laser system configured for removing at least a portion of the specimen.

32. The system of Embodiment 31, wherein removing includes vaporizing or eradicating the at least a portion of the specimen.

33. The system of Embodiment 31 or Embodiment 32, wherein the reader system comprises an optical system for reading a barcode or quick response (QR) code, a radio-frequency identification (RFID) system for reading an RFID tag, or an image capturing system for imaging the sample or a video capturing system for monitoring the sample, and wherein the information pertinent to the sample comprises one of a position, a location, or coordinates for the portion of interest.

34. The system of any one of Embodiments 31 to 33, wherein the ultra-short pulsed laser system comprises one of a femto-second laser system, a pico-second laser system, a nano-second laser system, or a micro-second laser system.

35. The system of any one of Embodiments 31 to 34, wherein the sample comprises a plurality of specimens, each specimen disposed on a substrate, and wherein the plurality of specimens are arranged linearly along one direction or arranged laterally in a two-dimensional array.

36. The system of any one of Embodiments 31 to 35, wherein the fixture is configured to hold the sample on outer edges of the substrate whereby the substrate is in contact with the fixture less than about 10% of lateral surface area of the substrate.

37. A method for automated sample preparation, the method comprising providing a substrate having a specimen disposed thereon; affixing the substrate to a fixture; providing a reader system configured for receiving information pertinent to the specimen; removing a plurality of portions of the specimen via an ultra-short pulsed laser system thereby forming the specimen with a region of interest; and collecting the specimen with the region of interest for laboratory testing.

38. The method of Embodiment 37, wherein removing via the ultra-short pulsed laser system includes removing the plurality of portions of the specimen without damaging the region of interest in the specimen.

39. The method of Embodiment 37 or Embodiment 38, wherein the substrate is affixed to the fixture on outer edges of the substrate whereby the substrate is in contact with the fixture less than about 10% of lateral surface area of the substrate.

40. The method of any one of Embodiments 37 to 39, wherein the substrate is affixed to the fixture on outer edges of the substrate whereby the substrate is in contact with the fixture less than about 1% of lateral surface area of the substrate.

41. The method of any one of Embodiments 37 to 40, wherein the substrate comprises a glass, a soda-lime glass, a polymer, a paraffin, filter paper, specimen collection paper, combination of binding chemistries, including N terminus, C terminus, extracellular matrix proteins.

42. The method of any one of Embodiments 37 to 41, wherein the ultra-short pulsed laser system comprises one of a femto-second laser system, a pico-second laser system, a nano-second laser system, or a micro-second laser system.

43. The method of any one of Embodiments 37 to 42, wherein the reader system comprises an optical system for reading a barcode or quick response (QR) code or a radio-frequency identification (RFID) system for reading an RFID tag.

44. The method of any one of Embodiments 37 to 43, wherein the information pertinent to the specimen comprises one of a position, a location, or coordinates for one or more regions of interest in the specimen.

45. The method of any one of Embodiments 37 to 44, wherein the reader system comprises an image capturing system for imaging the specimen or a video capturing system for monitoring the specimen.

46. The method of any one of Embodiments 37 to 45, wherein a plurality of substrates are affixed to the fixture, each of the plurality of substrates having a specimen, and the substrates are arranged linearly along one direction or arranged laterally in a two-dimensional array on the fixture.

1.-25. (canceled)

26. An automated sample preparation system comprising:
a fixture for holding a sample having a portion of interest;
a reader system configured for receiving information pertinent to the sample;
a laser system configured for isolating the portion of interest from the sample; and
a collection bin configured for collecting the isolated portion of interest.

27. The system of claim 26, wherein the sample comprises a plurality of portions of interest, the laser system isolates each of the plurality of portions of interest, and the collection bin collects each of the isolated portions of interest.

28. The system of claim 26, wherein the fixture holds the sample on its outer edges and the sample is in contact with the fixture less than about 10% of lateral surface area of the sample.

29. The system of claim 26, wherein the laser system comprises one of a femto-second laser system, a pico-second laser system, a nano-second laser system, a micro-second laser system, a carbon dioxide laser system, a mode-locked laser system, a pulsed-laser system, a Q-switched laser system, a Nd:YAG laser system, a continuous wave laser system, a dye-laser system, a tunable laser system, a Ti-Sapphire laser system, a high-power diode laser system, or a high-power fiber laser system.

30. The system of claim 26, wherein the reader system comprises an optical system for reading a barcode or quick response (QR) code, a radio-frequency identification (RFID) system for reading an RFID tag, or an image capturing system for imaging the sample or a video capturing system for monitoring the sample, and wherein the information pertinent to the sample comprises one of a position, a location, or coordinates for the portion of interest.

31. An automated sample preparation system comprising:
a fixture configured for securing a sample having a specimen disposed on a substrate;
a reader system configured for receiving information pertinent to the sample; and
an ultra-short pulsed laser system configured for removing at least a portion of the specimen.

32. The system of claim 31, wherein removing includes vaporizing or eradicating the at least a portion of the specimen.

33. The system of claim 31, wherein the reader system comprises an optical system for reading a barcode or quick response (QR) code, a radio-frequency identification (RFID) system for reading an RFID tag, or an image capturing system for imaging the sample or a video capturing system for monitoring the sample, and wherein the information pertinent to the sample comprises one of a position, a location, or coordinates for the portion of interest.

34. The system of claim 31, wherein the ultra-short pulsed laser system comprises one of a femto-second laser system, a pico-second laser system, a nano-second laser system, or a micro-second laser system.

35. The system of claim 31, wherein the sample comprises a plurality of specimens, each specimen disposed on a substrate, and wherein the plurality of specimens are arranged linearly along one direction or arranged laterally in a two-dimensional array.

36. The system of claim 31, wherein the fixture is configured to hold the sample on outer edges of the substrate whereby the substrate is in contact with the fixture less than about 10% of lateral surface area of the substrate.

37. A method for automated sample preparation, the method comprising:
providing a substrate having a specimen disposed thereon;
affixing the substrate to a fixture;
providing a reader system configured for receiving information pertinent to the specimen;
removing a plurality of portions of the specimen via an ultra-short pulsed laser system thereby forming the specimen with a region of interest; and
collecting the specimen with the region of interest for laboratory testing.

38. The method of claim 37, wherein removing via the ultra-short pulsed laser system includes removing the plurality of portions of the specimen without damaging the region of interest in the specimen.

39. The method of claim 37, wherein the substrate is affixed to the fixture on outer edges of the substrate whereby the substrate is in contact with the fixture less than about 10% of lateral surface area of the substrate.

40. The method of claim 37, wherein the substrate is affixed to the fixture on outer edges of the substrate whereby the substrate is in contact with the fixture less than about 1% of lateral surface area of the substrate.

41. The method of claim 37, wherein the substrate comprises a glass, a soda-lime glass, a polymer, a paraffin, filter paper, specimen collection paper, combination of binding chemistries, including N terminus, C terminus, extracellular matrix proteins.

42. The method of claim 37, wherein the ultra-short pulsed laser system comprises one of a femto-second laser system, a pico-second laser system, a nano-second laser system, or a micro-second laser system.

43. The method of claim 37, wherein the reader system comprises an optical system for reading a barcode or quick response (QR) code or a radio-frequency identification (RFID) system for reading an RFID tag.

44. The method of claim 37, wherein the information pertinent to the specimen comprises one of a position, a location, or coordinates for one or more regions of interest in the specimen.

45. The method of claim 37, wherein the reader system comprises an image capturing system for imaging the specimen or a video capturing system for monitoring the specimen.

46. The method of claim 37, wherein a plurality of substrates are affixed to the fixture, each of the plurality of substrates having a specimen, and the substrates are arranged linearly along one direction or arranged laterally in a two-dimensional array on the fixture.
